(19) United States
(12) Patent Application Publication
(10) Pub. No.: US 2025/0187868 A1
(43) Pub. Date: Jun. 12, 2025

(54) CABLE REEL ASSEMBLY

(71) Applicant: ALBRIGHT PRODUCT DESIGN LIMITED, Cheltenham, Gloucestershire (GB)

(72) Inventor: Alex Lee, Cheltenham, Gloucestershire (GB)

(21) Appl. No.: 18/843,779

(22) PCT Filed: Mar. 3, 2023
(86) PCT No.: PCT/GB2023/050499

§ 371 Date: Sep. 4, 2024

(30) Foreign Application Priority Data
Mar. 4, 2022 (GB) 2203016.7

(51) Int. Cl. B65H 75/44

(52) U.S. Cl. CPC B65H 75/4402; B65H 2701/34

(57) ABSTRACT

A cable reel assembly (10) for storing a cable (18) to be dispensed, the cable reel assembly (10) comprising a cylindrical rotatable reel (12) for storing a cable in a spiral configuration, and a cable restraining means (14) for restraining the movement of the cable (18) away from rotatable reel (12) during unwinding of the cable (18).

The present invention relates to a cable reel assembly for storing a cable to be dispensed and particularly but not exclusively to a cable reel assembly for an electric vehicle charging cable.

The present invention also related to an electric vehicle charging cable reel assembly for storing an electric vehicle charging cable to be dispensed and particularly but not exclusively to an electric vehicle charger comprising an electric vehicle charging cable reel assembly.

### BACKGROUND TO THE INVENTION

Typically, cable is stored by wrapping around a structure, such as a cable reel, or by hanging. These typically require manual operation to extend or retract the cable from its stowed position. For example, users may have to pull the cable from the cable reel to unspool it.

Users may not take proper care when extending or retracting the cable because they may not have enough time or are careless with equipment. This means that the cable can easily get tangled or damaged, needing it to be replaced frequently. Furthermore, the users may not retract the cable which leaves the cable unprotected potentially increasing the risk of further damage to the cable. Maintenance and replacement costs can, therefore, be very expensive.

Therefore, automatically operated cable dispensers are more preferable since the user does not have to manually operate the extension and/or retraction of the cable from the cable reel. This means that the cable is less likely to be damaged due to the lack of care of users.

However, other issues can arise when using manual cable reels or automated cable dispensers. For example, if there is insufficient tension on the dispensed end of the cable, the cable may not necessarily be dispensed correctly and/or retract properly or the cable may not wrap around the reel correctly. The lack of tension on the dispensed end of the cable causes the coiled cable to move away from the cable reel, i.e. the coiled cable diameter increases causing the coiled cable to get looser. This may can cause heat production from the cable rubbing against a surface which may cause damage to the cable reel or prevent proper functioning of the dispenser.

Some cable dispensers are also designed to allow the cable to be stowed as a stack of coils. While this saves space it may also increase heating within the coiled cable.

Many of these problems are exacerbated for electric vehicle charging cables. For example, the heat produced can be much greater. In another example, the size and/or stiffness of the cable makes it difficult to move between configurations. These cables are especially difficult to handle for disabled users or users with physical difficulties as they may find it difficult to move the cable without help from others.

It is an object of the present invention to reduce or substantially obviate the aforementioned problems.

### STATEMENT OF INVENTION

According to the present invention there is provided a cable reel assembly for storing a cable to be dispensed, the cable reel assembly comprising: a rotatable reel for storing a cable in a spiral configuration along the reel, the rotatable reel having a cylindrical body extending along a first longitudinal axis, the rotatable reel being rotatable about the first longitudinal axis; and a cable restraining means for restraining the movement of the coiled cable away from the first longitudinal axis during unwinding of the cable from the rotatable reel.

A cable restraining means is advantageous because it puts a restraint on the maximum movement of the cable away from the rotatable reel caused by a lack of sufficient tension on the cable. Put another way, the restraining means is provided so that it may restrain the increase in the coil diameter of the coiled cable caused be unwinding with insufficient tension applied to the cable. This can help reduce friction, especially when low friction surfaces or moving surfaces on the restraining means are used, which reduces strain on the means used to rotate the reel.

The movement of the cable away from the reel may be consider radial movement away from the longitudinal axis of the reel, i.e. uncoiling along a substantial part of the coiled length.

The term restraining may be considered as limiting to a maximum increase in coil diameter caused by movement of the coiled cable during unwinding. That is to say, the restraining means may allow for a predetermined increase in coil diameter caused by radial movement of the coiled cable during unwinding.

If sufficient tension is not applied to the cable when it is being dispensed, the coil diameter of the coiled cable will increase. This phenomenon happens when the cable reel is being drive by a motor, since the rate at which the cable leaves the cable reel is not the same as the rate of reel rotation due to lack of tension on the cable.

The cable restraining means may be considered as restraining the increase in coil diameter of the stored electric vehicle charging cable during unwinding of the electric vehicle charging cable. That is to say the increase in coil diameter is movement of the coiled electric vehicle charging cable away from the first longitudinal axis during unwinding of the electric vehicle charging cable from the rotatable reel.

The rotatable reel may be considered as a cable reel or a reel and may be referred to as such.

The first longitudinal axis may be considered the axis of rotation of the rotatable reel. The first longitudinal axis may extend through the centre of the rotatable reel.

The cable restraining means may comprise a cage. The cage may comprise a plurality of restraining elements. The restraining elements may be disposed around the rotatable reel. Each restraining element may be spaced away from a surface of the reel. Each restraining element may be disposed to an axis parallel to the first longitudinal axis. Each restraining element may extend at least the same distance as the rotatable reel.

The rotatable reel may be disposed within the cable restraining means. Preferably, the cage may enclose the rotatable reel. That is to say, that the cable restraining means, or cage, encircles the longitudinal length of the cylindrical body.

The rotatable reel may comprise an end flange extending perpendicularly away from the end of the cylindrical body.

The restraining means may be rotatable. That is to say, that the restraining means may rotate about an axis parallel to the first longitudinal axis. Each restraining element may rotate about its own axis, which is parallel to the first longitudinal axis, i.e., each restraining element has its own axis of rotation extending through the centre of the restraining element. Each restraining element may be a roller. The rotatable restraining means may freely rotate. Preferably, bearings may be provided to allow free rotation of the restraining means.

The restraining means may counter rotate with respect to the rotatable reel. At least some of the restraining means may counter rotate with respect to the rotatable reel. For example, the rotatable reel may rotate clockwise while at least some or the majority of the restraining elements rotates anti-clockwise. Rotational restraining means minimises friction on the cable.

A cable reel housing may be provided. The cable reel housing may enclose the cable restraining cage and cable reel.

A motor may rotate the rotatable reel. A transmission may be provided to couple the motor to the rotatable reel. The transmission may be a gear train. The transmission may be a belt.

The cable reel may be substantially hollow. The cylindrical body may be hollow. An inner cavity may be provided, the inner cavity may be substantially cylindrical.

A cable aperture may extend through the cylindrical body. The cable aperture may extend through the cylindrical body into an inner cavity. The cable aperture allows the cable to travel through the cylindrical body, i.e., from the internal cavity to a space external to the cylinder.

A cable may be provided. A portion of the cable may be substantially fixed to the cylindrical body, preferably fixed about the cable aperture. The fixation may be provided because of an increase in friction, for example from the size of the cable, the angle through the cable aperture, the contact area between the cable and reel about the cable aperture. Other fixation means may be provided, for example an adhesive, glue, bracket etc.

The cable may be only wounded around the reel once. The cable reel may only provide enough storage space for a single layer of coils along its length.

According to a second aspect of the present invention there is provided a cable reel assembly for storing a cable to be dispensed, the cable reel assembly comprising: a rotatable reel for storing a cable in a spiral configuration, the rotatable reel including a cylindrical body extending along a first longitudinal axis and a spiral separator for separating a cable wound around the reel, a cable receiving space being defined by adjacent sections of the spiral separator, the rotatable reel being rotatable about the first longitudinal axis; and a cable carriage movable along a second longitudinal axis parallel to the first longitudinal axis for guiding the cable to or from the receiving space, the cable carriage including an indexing wheel for indexing with the spiral separator, wherein rotation of the reel causes rectilinear motion of the cable carriage along the second longitudinal axis.

A carriage shaft may be disposed on the second longitudinal axis, the cable carriage being movably mounted to the carriage shaft. This allows the cable carriage to be slidable rectilinearly along the length of the cable reel or along the second longitudinal axis for guiding the cable to or from the cable receiving space.

The indexing wheel may comprise a central spindle with a concave surface for interfacing with the cable and an indexing flange disposed at each end of the central spindle. This aids the movement of the cable to or from the cable reel and ensures that the cable carriage is always aligned with the cable in the cable receiving space.

The indexing flanges may be spaced apart by a predetermined distance, the predetermined distance being larger than the distance between adjacent sections of the spiral separator. This allows the indexing wheel to always stay in contact with two adjacent sections of the spiral separator ensuring that the indexing wheel is always aligned with the cable receiving cavity.

The cable reel assembly may further comprise cable tensioning means. The cable tensioning means further aids the movement of the cable to or from the cable reel.

The tensioning means may comprise a tensioning roller.

A cable travel path may be defined by the indexing wheel and the cable tensioning means.

The cable travel path may be defined by the path between a cable contact point on the indexing wheel and a cable contact point on the cable tensioning means, the cable contact points being on either side of a plane extending between the axis of the indexing wheel and the axis of the tensioning means.

An upper surface of the cable may be in contact with the contact point of the indexing wheel and a lower surface of the cable may be in contact with the contact point of the tensioning means. The lower surface of the cable may be the surface contacting the rotatable reel when the cable is stowed, and the upper surface of the cable may be the surface opposite the lower surface of the cable.

The tensioning means may assist in reducing the speed of the cable movement away from the cylindrical body.

The distance between the indexing wheel and the cable tensioning means may vary. This allows the length of the cable travel path to be varied depending on what is desired or required. For example, it may be based on the flexibility of the cable, bend radius of the cable or a similar parameter of the cable.

The first aspect of the present invention may be provided with a spiral separator.

The spiral separator may extend around the cylindrical body. A cable receiving space may be defined between adjacent sections of the spiral separator. The spiral separator may extend substantially orthogonal from a surface of the cylindrical body. The spiral separator may comprise a wall extending around the surface of the cylindrical body. The wall may extend from the surface the same distance as the thickness of the cable. That is to say that the extent of the spiral separator may be substantially enough to receive the diameter of the cable. The spiral separator may be sized and shaped so as to allow a single layer of coils along the length of the rotatable reel.

The first aspect of the present invention may be provided with a cable carriage.

The cable carriage may be movably coupled to the rotatable reel. The cable carriage may guide the cable to or from the rotatable reel. The cable carriage may move rectilinearly along a longitudinal axis parallel to the first longitudinal axis. The rotatable reel may cause movement of the cable carriage.

The second aspect of the present invention may be provided with cable restraining means. The cable restraining means of the second aspect of the present invention may be the cable restraining means of the first aspect of the present invention.

The cable tensioning roller may be one of the cable restraining elements. Preferably the cable tensioning roller may be one of the rollers of the cable restraining cage.

The first aspect of the present invention may comprise features of the second aspect of the present invention. The second aspect of the present invention may comprise features of the first aspect of the present invention.

The cable may encompass an electric vehicle charging cable. That is to say, a cable comprising a plurality of conductive cables enclosed by insulation, wherein at least some of the conductive cables may be rated for charging electric vehicles. Data communication cables may also be provided in the electric vehicle charging cable. The term cable refers electric vehicle charging cable.

In another aspect of the present invention there is provided an electric vehicle charging cable reel assembly as claimed in claim 1. Preferred or optional features may be provided in claims 2 to 15.

In another aspect of the present invention there is provided an electric vehicle charging cable reel assembly as claimed in claim 16. Preferred or optional features may be provided in claims 17 to 23.

In another aspect of the present invention there is provided an electric vehicle charger comprising a cable reel assembly according to an aspect of the present invention discussed above. An electric vehicle charger comprising a cable reel assembly according to the first aspect of the present invention or as claimed in any one of claims 1 to 15 may be provided. In another example, an electric vehicle charger comprising a cable reel assembly according to the second aspect of the present invention or as claimed in any one of claims 16 to 23.

The electric vehicle charger may be an electric vehicle charging station. The electric vehicle charging station may also be considered an electric vehicle charging pile. The electric vehicle charging station may be a wall mounted unit, a free standing unit or a unit incorporated into a vehicle.

An electric vehicle charging cable may be provided. The electric vehicle charging cable may be the cable defined above. The electric vehicle charging cable may extend through a cable aperture in the cylindrical body.

The electric vehicle charger may be provided within an automobile. The electric vehicle charger may be a unit which is configured to be carried by hand.

The electric vehicle charger may comprise a housing enclosing the cable reel assembly. An opening may be provided in the housing. The housing may be the cable reel housing discussed above.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a perspective view of a cable reel assembly with a partially wound cable;

FIGS. 2a and 2b show side cross-sectional views of a cable reel assembly, FIG. 2a shows a coiled cable close to the cylindrical body and FIG. 2b shows the coiled cable in contact with cable restraining means;

FIG. 3 shows a cross-sectional view of the cable carriage in the cable reel assembly of FIGS. 2a and 2b; and

FIG. 4 shows a perspective view of the cable carriage in FIG. 3.

### DESCRIPTION OF PREFERRED EMBODIMENTS

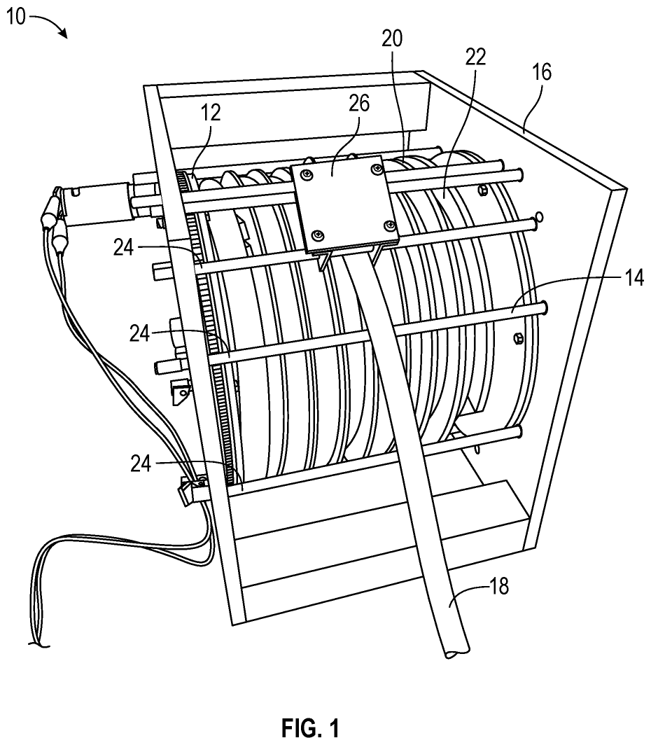

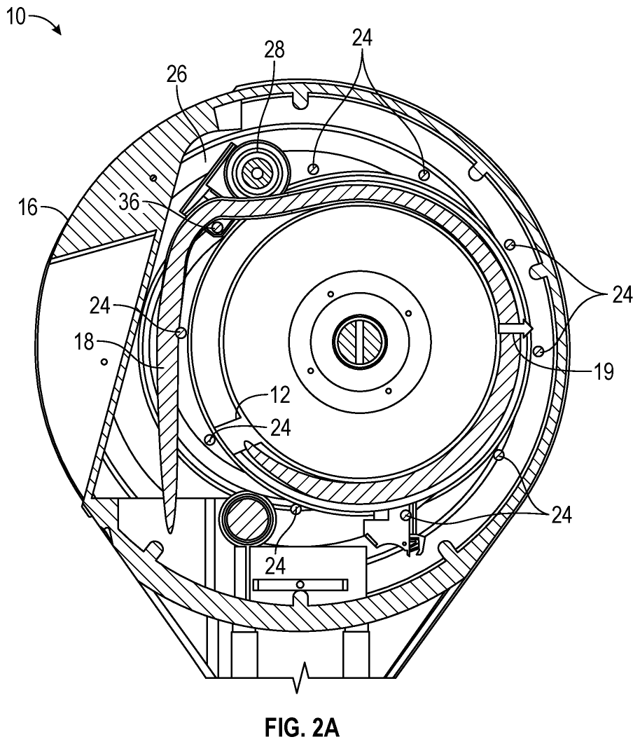

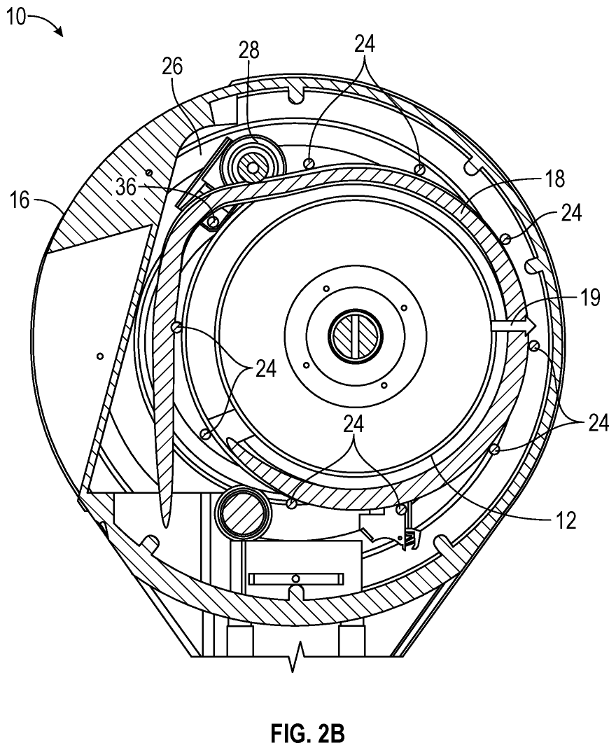

Referring to FIGS. 1, 2a and 2b, a cable reel assembly for storing a cable to be dispensed is generally indicated at 10. The cable reel assembly 10 comprises a rotatable reel 12 and a cable restraining means 14.

A housing 16 is provided around the cable reel assembly 10 for enclosing, protecting, and supporting the cable reel assembly 10.

The housing 16 can come in different shapes or forms for example, the housing 16 may be rectangular or cylindrical. The housing 16 can be made from plastics to aid the ventilation of the cable reel assembly 10. In the embodiment shown in FIG. 1, the housing 16 is formed from planar panels fixedly joined together. In the embodiments shown in the remaining figures, the housing 16 is provided by an enclosure. The housing 16 may be thought of as any structure to which the rotatable reel 12 and/or cable restraining means 14 are attached either directly or indirectly.

The rotatable reel 12 has a cylindrical body. The cylindrical body extend along a first longitudinal axis. The rotatable reel 12 is rotatable about the first longitudinal axis. The cylindrical body defines an internal cavity. The cylindrical body may be considered a drum.

Flanges extends outwards, i.e., away from the first longitudinal axis, from the ends of the cylindrical body.

The rotatable reel 12 has a spiral wall disposed between each flange (the spiral wall). The spiral wall extends perpendicularly away from the surface of the cylindrical body. The spiral wall extends from the surface by enough to allow the cable 18 to be received.

Preferably, the wall will extend approximately the diameter of the cable 18. However, the wall may extend at least the radius of the cable 18, but it may also extend more than the radius or diameter.

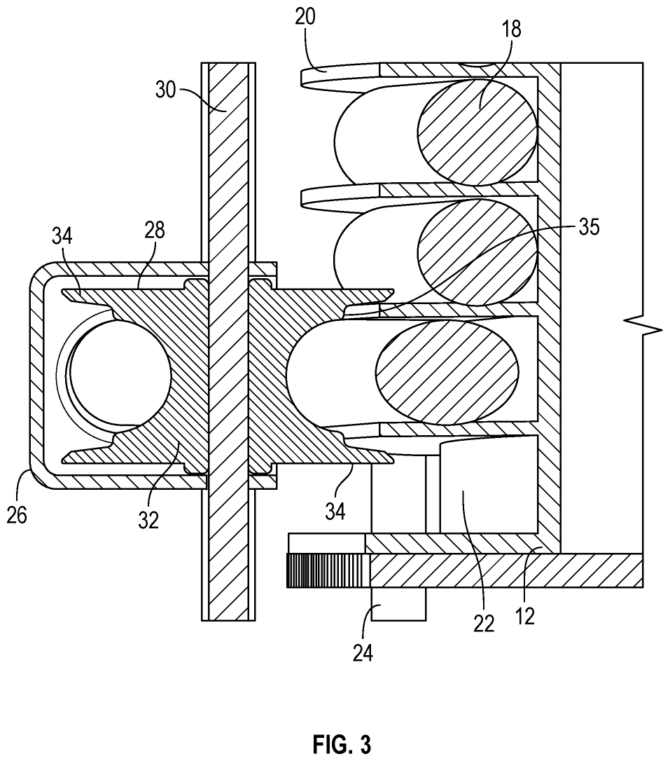

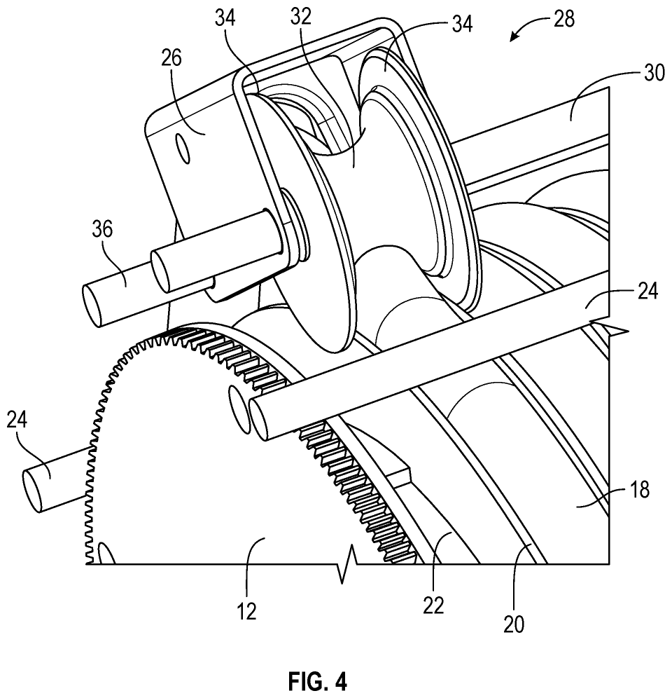

A cable receiving space 22 (also shown in FIGS. 3 and 4) is defined between adjacent sections of the spiral separator 20. The cable receiving space 22 has a width which is substantially the same as or slightly larger than the diameter of the cable 18. The cable 18 sits within the cable receiving space 22 when stowed.

The rotatable reel 12 is surrounded by the cable restraining means 14. The cable restraining means 14 comprises a cage having a plurality of cable restraining elements 24 such as rollers disposed around the circumference of the rotatable reel 12. In the current embodiment, there are ten restraining rollers spaced around the circumference of the rotatable reel. However, in other embodiments, there may be more or less restraining rollers provided.

Each restraining element 24 extends along an axis parallel to the first longitudinal axis by at least the same amount as the rotatable reel 12. The cable restraining elements 24 are spaced away from a surface of the rotatable reel 12, preferably spaced away from the surface of the cylindrical body and the extent of the spiral wall.

The cable restraining elements 24, 36 are enclosed within the housing 16, where both ends of each cable restraining elements 24,36 are connected to sides of the housing 16. The cable restraining elements are rotatable or free to rotate about an axis parallel to the first longitudinal axis. Ball bearings, for example, can be provided at the ends of the cable restraining elements 24 of the cable restraining means 14 to allow the cable restraining elements 24 to freely rotate.

When the rotatable reel 12 is rotated, for example by a motor, to unwind the cable 18 from the cable reel assembly 10, the cable 18 starts to expand or move away from the cylindrical body of the rotatable reel 12 and move towards the cable restraining elements 24, 36 (As shown in arrow 19 of FIGS. 2a and FIG. 2b). The movement of the cable 18 is a result of a lack of sufficient tension on the cable 18. Once the cable 18 is in contact with the cable restraining elements 24, 36, the cable 18 cannot move further away from the rotatable reel 12. The cable restraining elements 24 thereby, restrain the movement of the cable 18 away from the first longitudinal axis during unwinding of the cable 18 from the cable reel assembly 10.

As the cable 18 extends out of the cable reel assembly 10 as the rotatable reel 12 rotates, the cable restraining elements 24 counter rotate with respect to the rotation of the rotatable reel 12. The rotatable restraining elements reduce heat build-up from friction and reduces demand on the motor used to rotate the reel 12.

The restraint of the movement of the cable 18 by the cable restraining elements 24 within the cable reel assembly 10 and the rotation of the cable restraining elements 24 together allow the cable 18 to extend out of the cable reel assembly 10. This thereby unwinds the cable 18 from the rotatable reel 12.

In addition, when the rotatable reel 12 is actuated to rotate to wind the cable 18 onto the rotatable reel 12, i.e., retract the cable, the cable restraining elements 24 counter rotate with respect to the rotation of the rotatable reel 12 as the cable 18 is retracted into the cable reel assembly 10. This will typically only happen for a short period as the cable 18 is drawn back into contact with the cylindrical body of the rotatable reel 12.

A cable aperture (not shown) extends through the cylindrical body of the rotatable reel 12 into an inner cavity (not shown) at the centre of the rotatable reel 12. This allows the cable 18 to travel from the inner cavity of the rotatable reel 12 to a space external to the cylindrical body. This allows a portion of the cable 18 that has reached the space external to the cylindrical body to be wound around the rotatable reel 12 for extending and/or retracting in and out of the cable reel assembly 10. A portion of the cable 18 located within the cable aperture is fixed to the rotatable reel 12.

A cable carriage 26 is provided on the cable reel assembly 10 and is movably coupled to the rotatable reel 12. The cable carriage 26 is shown in more detail in FIGS. 3 and 4 and discussed in more detail below.

The cable carriage 26 is part of the circumference of the rotatable reel 12. The cable carriage 26 guides the cable 18 to or from the rotatable reel 12 or in other words, in and out of the cable reel assembly 10, when unwinding or winding the cable 18 around the rotatable reel 12. The cable carriage 26 can move rectilinearly along a second longitudinal axis parallel to the first longitudinal axis. When the rotatable reel 12 is actuated to rotate, the rotation of the rotatable reel 12 causes movement of the cable carriage 26 along the length of the rotatable reel 12.

Referring to FIGS. 3 and 4, the cable carriage 26 includes an indexing wheel 28 for indexing with the spiral separator 20 on the rotatable reel 12. The rotation of the rotatable reel 12 causes rectilinear motion of the cable carriage 26 along the second longitudinal axis which follows the indexing of the spiral separator 20.

The indexing wheel 28 comprises a central spindle 32 with a concave surface. The concave surface allows the indexing wheel 28 to interface with part of the cable 18. An indexing flange 34 is disposed at each end of the central spindle 32 and are spaced apart by a predetermined distance. The predetermined distance between the indexing flanges 34 is larger than the distance between the adjacent sections of the spiral separator 20. This allows the indexing wheel 28 to always stay in contact with two adjacent sections of the spiral separator 20.

Each indexing flange 34 may have an abutment shoulder 35. The abutment shoulder interfacing with the upper portion of the spiral wall.

A carriage shaft 30 is disposed on the second longitudinal axis. Both ends of the carriage shaft 30 are connected and fixed to the sides of the housing 16. The carriage shaft may be fixedly connected, i.e., no rotation possible, or rotatably attached, for example by bearings. The cable carriage 26 is movably mounted to the carriage shaft 30. This allows the cable carriage 26 to move slidably along the length of the rotatable reel 12 when the cable 18 is being wounded or unwounded on the rotatable reel 12.

A cable tensioning means 36 is provided such as a tensioning roller on the cable reel assembly 10. In the current embodiment, a restraining element of the restraining means 14 provides the cable tensioning means 36. In other embodiments, the tensioning means 36 may be provided by some other roller.

Both ends of the cable tensioning means 36 are connected to the sides of the housing 16. The cable tensioning means 36 aids the cable reel assembly 10 to extend or retract the cable 18 to or from the rotatable reel 12.

A cable travel path, best seen in FIGS. 2A and 2B, is defined by the indexing wheel 28 and the cable tensioning means 36. Specifically, the cable travel path is defined by the path between a cable contact point on the indexing wheel 28 and a cable contact point on the cable tensioning means 36. The cable contact points are on either side of a plane extending between the axis of the indexing wheel 28 and the axis of the tensioning means 36. An upper surface of the cable 18 is in contact with the contact point of the indexing wheel 28 and a lower surface of the cable 18 is in contact with the contact point of the tensioning means 36. The lower surface of the cable 18 is the surface contacting the rotatable reel 12 when the cable 18 is stowed and the upper surface of the cable 18 is the surface opposite the lower surface.

The distance between the indexing wheel 28 and the cable tensioning means 36 can vary depending on what is desired. For example, the distance between the indexing wheel 28 and the cable tensioning means 36 can be increased to allow the cable travel path to be further controlled.

The embodiments described above are provided by way of example only, and various changes and modifications will be apparent to persons skilled in the art without departing from the scope of the present invention as defined by the appended claims.

1-23. (canceled)

24. An electric vehicle charging cable reel assembly for storing an electric vehicle charging cable to be dispensed, the electric vehicle charging cable reel assembly comprising:
a rotatable reel for storing the electric vehicle charging cable in a coiled configuration along a length of the rotatable reel, the rotatable reel having a cylindrical body extending along a first longitudinal axis, the rotatable reel being rotatable about the first longitudinal axis, wherein the rotatable reel is operably driven by a motor; and
a cable restraining means for restraining a movement of the electric vehicle charging cable in the coiled configuration away from the first longitudinal axis during unwinding of the electric vehicle charging cable from the rotatable reel.

25. The electric vehicle charging cable reel assembly as claimed in claim 24, wherein the cable restraining means comprises a cable restraining cage having a plurality of restraining elements disposed around the rotatable reel, each restraining element of the plurality of restraining elements being spaced away from a surface of the rotatable reel.

26. The electric vehicle charging cable reel assembly as claimed in claim 24, wherein the rotatable reel is disposed within the cable restraining means.

27. The electric vehicle charging cable reel assembly as claimed in claim 24, wherein the cable restraining means is rotatable.

28. The electric vehicle charging cable reel assembly as claimed in claim 27, wherein the cable restraining means counter rotates with respect to the rotatable reel.

29. The electric vehicle charging cable reel assembly as claimed in claim 25, wherein the restraining elements are rollers.

30. The electric vehicle charging cable reel assembly as claimed in claim 29, wherein the cable restraining means is free to rotate.

31. The electric vehicle charging cable reel assembly as claimed in claim 25, further comprising a cable reel housing enclosing the cable restraining cage and rotatable reel.

32. The electric vehicle charging cable reel assembly as claimed in claim 24, wherein a cable aperture extends through the cylindrical body into an inner cavity for allowing the electric vehicle charging cable to travel from the inner cavity to a space external to the cylindrical body.

33. The electric vehicle charging cable reel assembly as claimed in claim 24, wherein a portion of the electric vehicle charging cable is fixed to the rotatable reel.

34. The electric vehicle charging cable reel assembly as claimed in claim 24, wherein the electric vehicle charging cable is only wound around the rotatable reel once.

35. The electric vehicle charging cable reel assembly as claimed in claim 24, wherein the rotatable reel comprises a spiral separator extending around the cylindrical body, a cable receiving space being defined between adjacent sections of the spiral separator.

36. The electric vehicle charging cable reel assembly as claimed in claim 35, wherein the spiral separator extends substantially orthogonally from a surface of the cylindrical body, a spiral wall of the spiral separator extending by substantially the same distance as a thickness of the electric vehicle charging cable.

37. The electric vehicle charging cable reel assembly as claimed in claim 24, further comprising a cable carriage movably coupled to the rotatable reel for guiding the electric vehicle charging cable to or from the rotatable reel, wherein the cable carriage is configured to move rectilinearly along a second longitudinal axis parallel to the first longitudinal axis.

38. The electric vehicle charging cable reel assembly as claimed in claim 37, wherein rotation of the rotatable reel causes movement of the cable carriage.

39. An electric vehicle charging cable reel assembly for storing an electric vehicle charging cable to be dispensed, the electric vehicle charging cable reel assembly comprising:
a rotatable reel for storing the electric vehicle charging cable in a coiled spiral configuration along a length of the rotatable reel, the rotatable reel including a cylindrical body extending along a first longitudinal axis and a spiral separator for separating the electric vehicle charging cable wound around the rotatable reel, an electric vehicle charging cable receiving space being defined by adjacent sections of the spiral separator, the rotatable reel being rotatable around the first longitudinal axis, wherein the rotatable reel is operably driven by a motor; and
a cable carriage movable along a second longitudinal axis parallel to the first longitudinal axis for guiding the electric vehicle charging cable to or from the electric vehicle charging cable receiving space, the cable carriage including an indexing wheel for indexing with the spiral separator, wherein rotation of the rotatable reel causes rectilinear motion of the cable carriage along the second longitudinal axis.

40. The electric vehicle charging cable reel assembly as claimed in claim 39, further comprising a carriage shaft disposed on the second longitudinal axis, the cable carriage being movably mounted to the carriage shaft.

41. The electric vehicle charging cable reel assembly as claimed in claim 39, wherein the indexing wheel comprises a central spindle with a concave surface for interfacing with the electric vehicle charging cable and an indexing flange disposed at each end of the central spindle.

42. The electric vehicle charging cable reel assembly as claimed in claim 41, wherein the indexing flanges are spaced apart by a predetermined distance, the predetermined distance being larger than a distance between adjacent sections of the spiral separator.

43. An electric vehicle charging cable reel assembly for storing an electric vehicle charging cable to be dispensed, the electric vehicle charging cable reel assembly comprising:
a rotatable reel for storing the electric vehicle charging cable in a coiled configuration along a length of the rotatable reel, the rotatable reel including a cylindrical body extending along a first longitudinal axis and a spiral separator extending around the cylindrical body, the rotatable reel being rotatable about the first longitudinal axis, wherein the rotatable reel is operably driven by a motor, and wherein a cable receiving space being defined between adjacent sections of the spiral separator; and
a rotatable cable restraining means for restraining movement of the electric vehicle charging cable in the coiled configuration away from the first longitudinal axis during unwinding of the electric vehicle charging cable from the rotatable reel, the rotatable cable restraining means comprising a cable restraining cage having a plurality of restraining elements disposed around the rotatable reel, each restraining element of the plurality of restraining elements being spaced away from a surface of the rotatable reel.
